(19) United States
(12) Patent Application Publication
(10) Pub. No.: US 2008/0107782 A1
(43) Pub. Date: May 8, 2008

(54) PROCESS FOR PACKAGING AND STORING CORNED BEEF IN FLEXIBLE PACKAGING FOR POSTERIOR SLICING

(76) Inventor: Fernando Antonio Bertin, Lins (BR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/748,810

(22) Filed: May 15, 2007

(30) Foreign Application Priority Data
Nov. 7, 2006 (BR) PI-0605061-1

(51) Int. Cl. B65D 85/00; A23L 3/10

(52) U.S. Cl. 426/129; 426/411

(57) ABSTRACT

A new safer and cost-reducing packaging and storing system and product to store corned beef, in a flexible packaging for a posterior slicing step.

### RELATED APPLICATION

The present application claims priority to Brazilian Application No. PI-0605061-1 filed Nov. 7, 2006, which is incorporated herein in its entirety by reference.

### BACKGROUND OF THE INVENTION

1. Field of the Invention

The present invention refers to new packaging and storing system and product for corned beef, for a posterior slicing step.

2. Description of the Prior Art

Corned beef for slicing known in the art is typically packaged using metallic cans weighting between 6 pounds (2.720 kg) and 14 pounds (6.350 kg).

However this type of storage presents several drawbacks and disadvantages, such as: (a) difficult removal of the corned beef from the interior of the metallic cans for the slicing process; (b) high accident rates, mainly cuts, due to the need of cutting and handling metallic cans; (c) great risk of contamination of corned beef by the metallic scraps generated during the procedure of can opening; (d) contamination of the corned beef by an eventual oxidation of the metallic cans; (e) high waste index of corned beef when removing it from the interior of the metallic cans; and (f) unacceptance of some specific sterilization processes of product packaged in metallic cans.

The above-mentioned waste of corned beef involves increased industrial costs of the slicing process, a fact that impacts negatively in the profit margin of the slicing company.

From the point of view of the transportation, corned beef packaged in metallic cans creates a great volume and weight, incurring in higher freight costs. Since metallic cans present significant greater weight, when added to the global weight of the lot to be transported, costs are highly increased and, even worse, less safe.

What is needed therefore is a new process for packaging and storing corned beef and packaged corned beef for a posterior slicing process, which is based in its packaging and storing in a flexible packaging, in predetermined shapes, preferably in a retort pouch type, where its use eliminates all previously discussed drawbacks and identified negative aspects.

### SUMMARY OF THE INVENTION

The present invention provides a new process for packaging corned beef in a flexible container for future slicing, a process for storing corned beef packaged in a flexible container and a corned beef packaged in a flexible container for a posterior slicing step.

The flexible package is preferably of a retort pouch type, presenting advantages as to allow sterilization, thus aggregating value since it increases the shelf life of the packaged product, which allows the slicing company to work with a shelf live of up to 18 months.

Additionally, when using a retort pouch type packaging a significant reduction of loss of corned beef is observed when removing it from its packaging to the posterior slicing process.

The process and product of the present invention automatically drives to a reduction of the manufacturing costs, mainly when corned beef is removed from the retort pouch type packaging to be sent to the slicing process. Furthermore, the easy removal of corned beef from the packaging is a factor that increases the productivity related to the set up of the slicing process.

At its turn it is important to highlight that the use of the retort pouch type packaging provokes minimal changes during the preparation process of corned beef, thus innovating the packaging process.

### BRIEF DESCRIPTION OF THE DRAWINGS

FIG. 1 is a perspective view of the shaping box of the flexible packaging.

FIG. 2 is a perspective view of the flexible packaging, a retort pouch.

FIG. 3 is a perspective view of a flexible packaging, a retort pouch, immediately before being opened, and the opening process.

FIG. 4 is a perspective view of corned beef inside an opened flexible packaging.

### DETAILED DESCRIPTION OF THE INVENTION

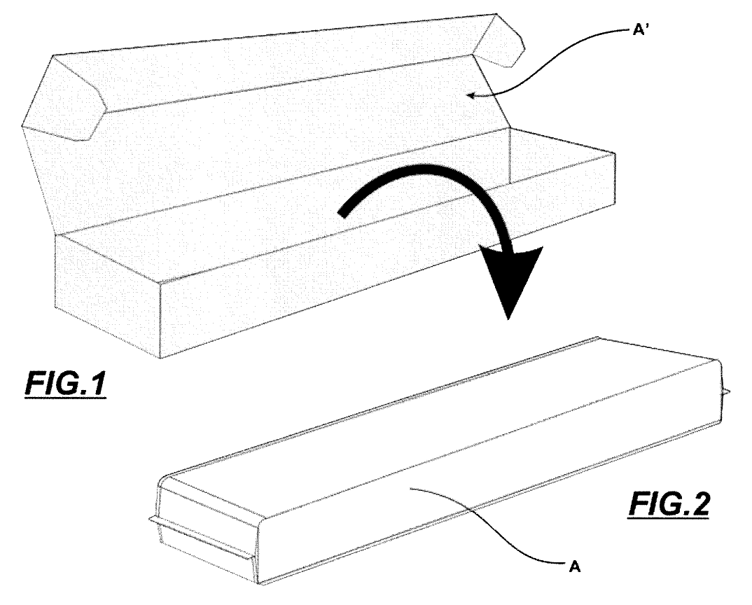

In FIG. 1 it is shown a shaping box (A′), whose function is to accommodate and confer final shape to the packaging containing corned beef (not shown).

In FIG. 2 it is shown packaging (A) containing corned beef (not shown). This packaging is of retort pouch type, however, any other type that presents similar characteristics of flexibility, prolonged conservation of a perish product (shelf live of at least 18 months) and also allows full sterilization of the same one is also possible.

In a preferred embodiment, packaging (A) is a retort pouch presenting a rectangular shape 135 mm long×95 mm wide. In another embodiment not shown, the packaging is of a square shape 114 mm×114 mm each side.

The volume of corned beef stored in the rectangular and square shapes packaging may vary from 6 pounds (2.720 kg) to 18 pounds (8.160 kg).

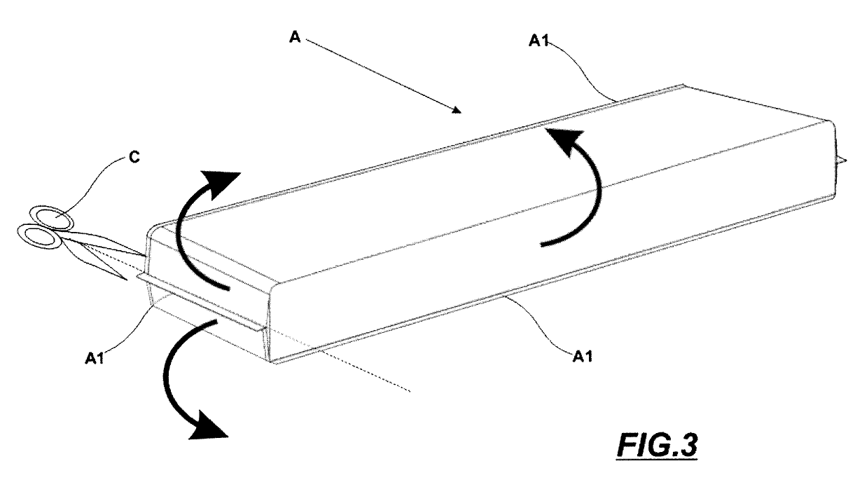

FIG. 3 indicates the opening process for packaging A, where the opening is easily obtained through the cut, with a cutting instrument (C), of the closing edges (A1).

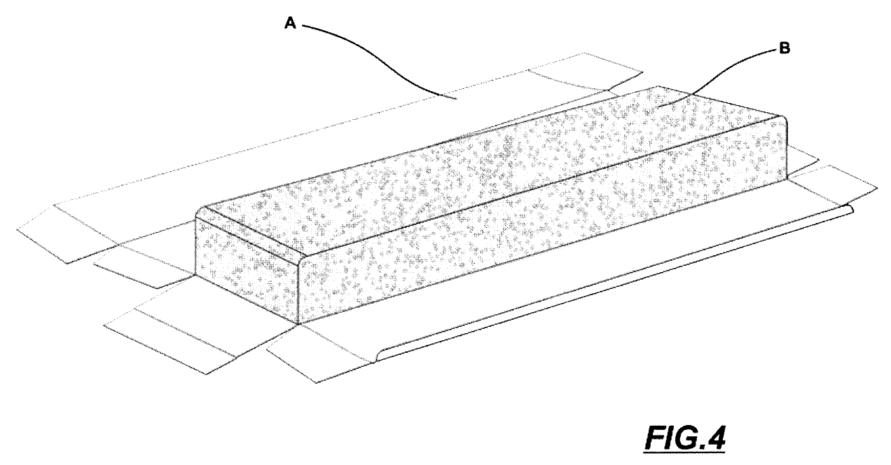

FIG. 4 shows corned beef (B) inside an opened packaging (A) after applying the opening process described in FIG. 3.

This innovative manner of packaging and storing corned beef aggregates value from the point of view of its manufacturing, storing and transportation processes. Additionally, this packaging system creates a more safe product for storing, handling, and transporting.

The process for manufacturing corned beef includes the following sequential steps:

(i) Cooking the meat: the crushed bovine meat is cooked under suitable parameters of temperature and pressure known in the art, in continual cookers for about five minutes;

(ii) Mixture preparation: the cooked bovine meat is transferred to a mixer where ingredients as salt, sugar and nitrite are added, obtaining a final mass of meat and ingredients;

(iii) Corned beef obtainment: after mixing all ingredients the final mass is put in vacuum packagers, where corned beef (B) is formed;

The new process for packaging and storing of corned beef in a flexible container for future slicing, includes then:

(1) Packaging: the formed corned beef (B) is directly packaged in a flexible packaging (A), preferably a retort pouch;

(2) Sealing and compacting: the packaged corned beef (B) is transferred to a vacuum sealing equipment, where the packaging (A) is first sealed and then compacted, being this compaction made possible by the vacuum of this process;

(4) Sterilization: packaging (A), is placed in an autoclave, with controlled pressure and temperature to proceed with the sterilization. The packaging (A) is exposed to a temperature of 121° C. and a pressure of 2.2 bar. In accordance with the dimensions of the packaging (A) this step may last up to 6 hours;

(5) Drying: the packaging is dried;

(6) Shaping: the packaging (A) duly dried does not present the defined final shaping.

Packaging is then placed inside individual cartoon boxes, shaping boxes (A′), presenting several geometric shapes, such as cubic, quadrate and cylindrical, among others.

(7) Storing: the flexible packaging (A) is stored for posterior transportation to the slicing company.

Thus the use of a flexible packaging, preferably retort pouch, provides several advantages such as: (a) easy removal and release of the corned beef during the slicing process; (b) elimination of accident risks, mainly cuts, since the flexible packaging does not present sharp points or regions; (c) elimination the risks of contamination of the corned beef since it allows for receiving a sterilization process, and also by presenting an aluminum internal film, which will prevent oxidation points; (d) corned beef waste index tending to zero when removing it from the packaging, decreasing the industrial costs of the slicing process, impacting positively over the profit margin of the slicing company; and (e) creating less volume and weight, incurring in lower transportation and freight costs.

1. A process for packaging and storing corned beef in a flexible container for future slicing, the process including the steps of:
(1) placing a pre-manufactured corned beef in a flexible packaging;
(2) sealing and compacting the packaged corned beef;
(3) placing the packaged and sealed corned beef in an autoclave, applying temperature of 121° C. and pressure of 2.2 bar and suitable time, sterilizing the packaged corned beef;
(4) drying the packaged corned beef at suitable temperature, pressure and time;
(5) placing the duly dried packaged corned beef inside an individual cartoon shaping box, presenting any desired geometric shape, shaping the packaged corned beef.

2. The process for packaging and storing corned beef in a flexible container according to claim 1, wherein the flexible packaging is a retort pouch type packaging.

3. The process for packaging and storing corned beef in a flexible container according to claim 1, wherein the geometric shape of the shaping box is selected from the group consisting of: cubic, square, rectangular and cylindrical.

4. The process for packaging and storing corned beef in a flexible container according to claim 3, wherein the geometric shape of the shaping box is a 135 mm long×95 mm wide rectangular shape package containing 2.720 kg of corned beef.

5. The process for packaging and storing corned beef in a flexible container according to claim 3, wherein the geometric shape of the shaping box is a 114 mm×114 mm square shape package containing 8.160 kg of corned beef.

6. A Corned beef, packaged in a flexible container manufactured according to the process of claim 1.

7. The corned beef packaged in a flexible container according to claim 7, wherein the flexible packaging includes closing edges.

8. The corned beef packaged in a flexible container according to claim 7, wherein the flexible packaging is accommodated and shaped into an outer shaping box.
